(19) United States
(12) Patent Application Publication
(10) Pub. No.: US 2024/0174333 A1
(43) Pub. Date: May 30, 2024

(54) ROBOTIC MODULAR SUBMERSIBLE DEVICE AND METHODS

(71) Applicant: Agellus TankBOT 360 Inc., Cypress, TX (US)

(72) Inventor: DAMIEN GOODYEAR, Cypress, TX (US)

(73) Assignee: Agellus TankBOT 360 Inc., Cypress, TX (US)

(21) Appl. No.: 17/791,065

(22) PCT Filed: Jan. 24, 2022
(86) PCT No.: PCT/US2022/013523

§ 371 Date: Jul. 28, 2022

Related U.S. Application Data
(60) Provisional application No. 63/199,760, filed on Jan. 22, 2021.

(51) Int. Cl. B63G 8/00; B63G 8/08; B63G 8/16

(52) U.S. Cl. CPC B63G 8/001; B63G 8/08; B63G 8/16; B63G 2008/005

(57) ABSTRACT

A remote modular submersible device is suitable for various subsurface operations in a liquid, such as freshwater, salt water, hydrocarbon(s), and/or chemical(s). The remote modular submersible device includes a chassis and a clamping system in the chassis. The clamping system is configured to clamp the chassis to an elongate member. The remote modular submersible device also includes a propulsion system in the chassis. The propulsion system is configured to propel and orient the chassis in a liquid in which the chassis is submerged. The remote modular submersible device additionally includes a processor configured to control at least the propulsion system.

### BACKGROUND OF THE INVENTION

The present invention relates generally to robotic devices, and more particularly, to robotic submersible devices suitable for operations while submerged in a liquid.

### BRIEF SUMMARY

Embodiments of a robotic modular submersible device (RMSD) and associated methods are disclosed. The RMSD can be utilized while submerged in a liquid, such as freshwater, salt water, hydrocarbon(s), and/or chemical(s), for various subsurface operations. These subsurface operations can include tank cleaning, infrastructure inspection, and positioning an elongate member, such as a cable, conduit, pipeline, tube, fluid hose, etc. For example, positioning the elongate member may include extending (e.g., uncoiling or unspooling), retracting (e.g., coiling or spooling), orienting, manipulating, bending, straightening, and/or maneuvering the elongate member.

In various embodiments, the RMSD can include a chassis, an electronics housing, a propulsion system, a communication system, a buoyancy system, a clamping system, an orientation system, a power system, and/or a cable system. In various embodiments, these features can be implemented in separate hardware components or, in some cases, integrated into common hardware components. These features have been outlined, rather broadly, in order that the following detailed description may be better understood. Additional and alternative features are described hereinafter.

In some embodiments, the propulsion system of the RMSD creates vectored liquid flow from multiple nozzles, permitting the RMSD to be oriented, positioned, and propelled within the liquid in which it is submerged. The propulsion system may include one or more propellers (screws).

In some embodiments, the clamping system of the RMSD allows the RMSD to be attached or clamped to an elongate member, which in some cases may be flexible. In some use cases, multiple RMSDs may be coupled to the elongate member at various different positions along its length. The elongate member may thus be extended, retracted, translated, oriented, manipulated, and/or maneuvered within the liquid in which the RMSDs are submerged.

### BRIEF DESCRIPTION OF THE SEVERAL VIEWS OF THE DRAWINGS

FIG. 1 is an top plan view of an exemplary embodiment of a robotic modular submersible device (RMSD) in a closed configuration;

FIG. 2 is a left side elevation view of the RMSD of FIG. 1, with the right side elevation view being a mirror image;

FIG. 3 is a front perspective view of the RMSD of FIG. 1 in an open or unclamped configuration;

FIG. 4 is an exploded perspective view of the RMSD of FIG. 1 with two shells disassembled from one another;

FIG. 5 is a top perspective view of the RMSD of FIG. 1;

FIGS. 6-7 are rear perspective views of the RMSD of FIG. 1 showing various closure elements;

FIGS. 8-9 depict multiple RMSDs working in combination to extend, retract, bend, position, and/or re-configure an elongate member; and

FIG. 10 depicts exemplary electronics for the RMSD of FIG. 1.

### DETAILED DESCRIPTION

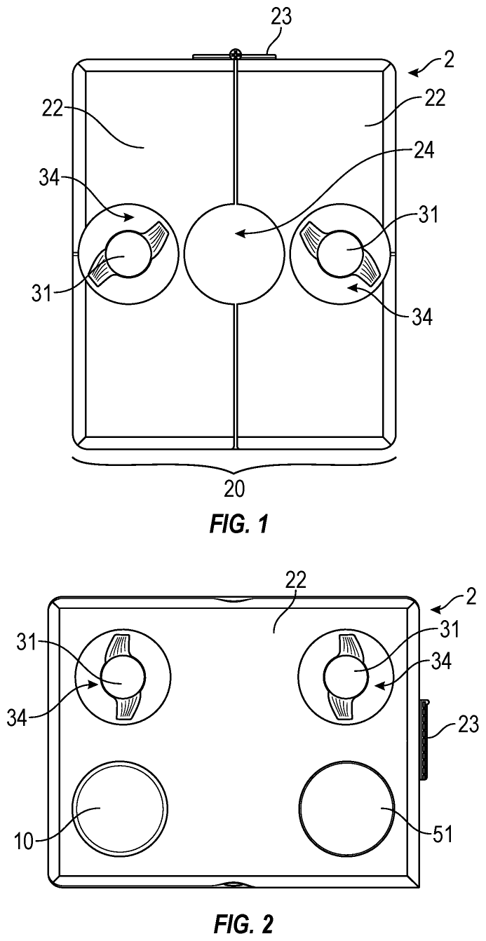

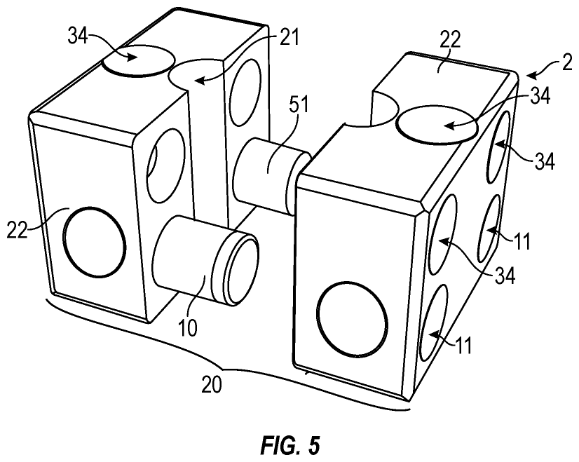

With reference now to the figures, in which like reference numerals refer to like and corresponding parts throughout, and in particular with reference to FIGS. 1 to 7, there is illustrated a robotic modular submersible device (RMSD) 2 in accordance with one or more embodiments.

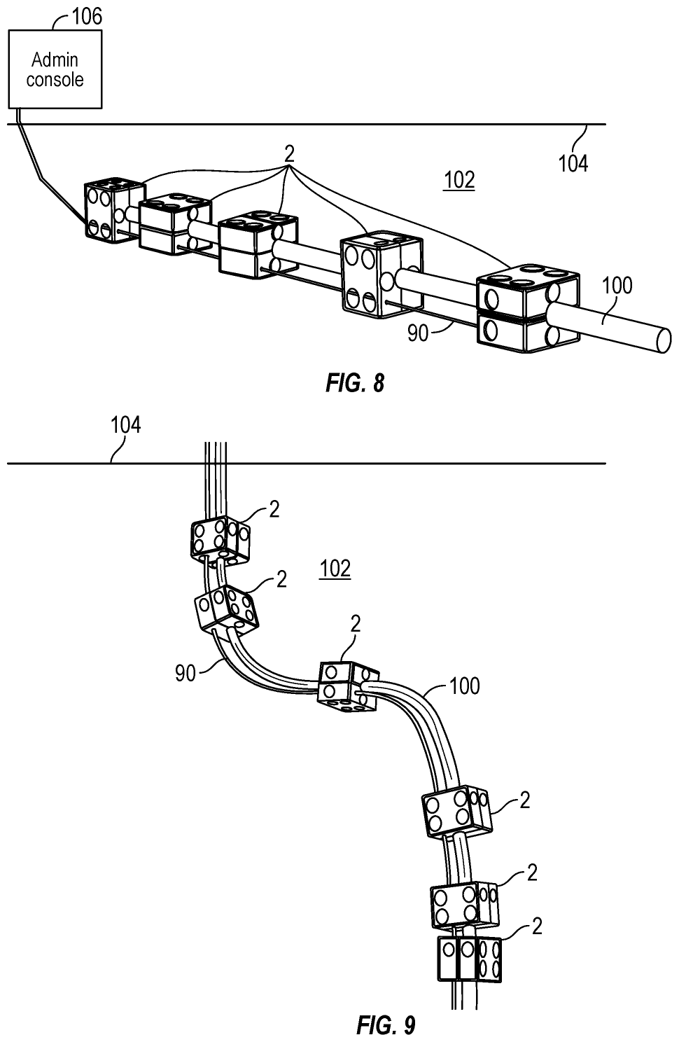

In the illustrated embodiment, RMSD 2 includes a chassis 20, which is a mechanical structure that encloses, supports, and/or is coupled to all other components of RMSD 2. Chassis 20 is a primary structural component which may be used to assemble, group, and/or package other components of RMSD 2 together into a complete modular unit. In some embodiments, chassis 20 may be integrated with one or more other components of RMSD 2 shown discretely in the drawings for ease of understanding. In at least some embodiments, chassis 20 is formed of a material, such as a metal or plastic, which is resistant to degradation due to being submerged in a liquid fluid (e.g., freshwater, salt water, hydrocarbon(s), and/or chemical(s), etc.). In at least some embodiments, chassis 20 may be structured to permit RMSD 2 to be selectively and fixedly clamped about and/or unclamped from an elongate member 100 (see, e.g., FIGS. 8-9), such as a cable, conduit, pipeline, tube, fluid hose, etc. In at least some embodiments, chassis 20 may have the overall form of a rectangular prism. Of course, in other embodiments, chassis 20 may be implemented with an alternative overall form. In some examples, one or more surfaces of chassis 20 can be constructed of differing shapes or materials in order to provide differing signatures when irradiated with electromagnetic energy or when reflecting sonic waves. In this way, chassis 20 can passively indicate its position and/orientation to an external monitoring sensor array.

In at least some embodiments, chassis 20 can be formed of multiple parts. In one example, chassis 20 includes two or more shells 22. In some embodiments, shells 22 forming chassis 20 can be of the same or similar dimensions. For example, two shells 22 forming a chassis 20 can be mirror images of one another.

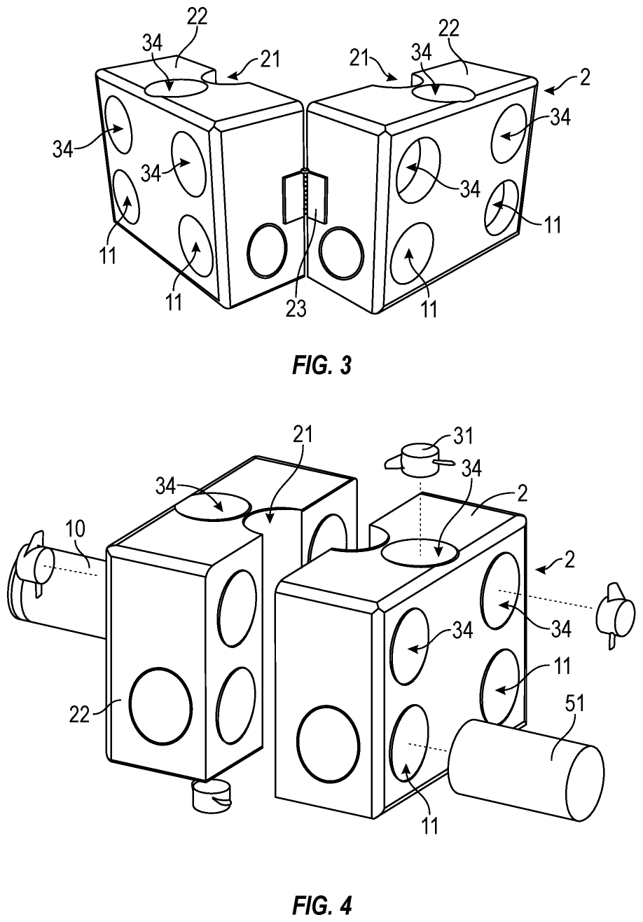

Shells 22 can be coupled by one or more closure elements. For example, shells 22 can be pivotally coupled by a hinge 23 (best seen in FIGS. 1 to 3) that allows shells 22 to be rotated between an open or unclamped position, such as that illustrated in FIG. 3, and a closed or clamped position, as shown in FIG. 1. Shells 22 may in some embodiments alternatively or additionally be coupled by one or more straps, chains, and/or cables. Alternatively or additionally, shells 22 may be coupled together by a hasp and pin, a plate and fasteners, bolts, magnets (e.g., electromagnets controlled by a processor 200), or other closure elements.

In the illustrated embodiments, each of shells 22 includes a corresponding recess 21 sized and configured to receive therein an elongate member 100, such as a cable, conduit, pipeline, tube, fluid hose, etc. Recesses 21 together form a bore 24 through chassis 20 that permit shells 22 to be removably clamped about the elongate member 100 such that chassis 20 maintains a fixed position relative to the elongate member 100, even in the presence of forces such as gravitational force, hydraulic forces (e.g., waves and currents), propulsive forces, buoyant forces, etc. In some embodiments, the one or more closure elements include a tensioning system that allows the clamping force of shells 22 applied to the elongate member 100 to be selectively increased and/or decreased.

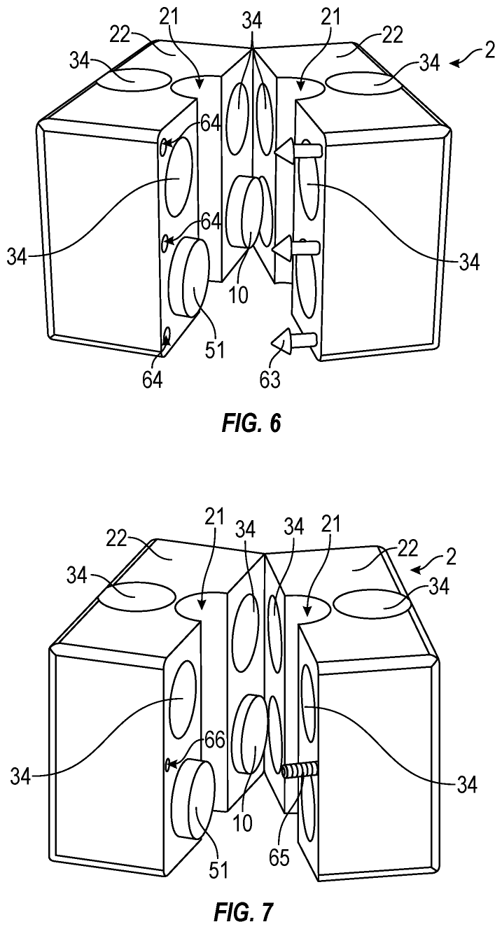

FIGS. 6-7 are rear perspective view of RMSD 2 illustrating exemplary automated closure elements that support processor-controlled clamping and unclamping of RMSD 2. In particular, FIG. 6 depicts an example in which one shell 22 has one or more arrowhead-shaped pins 63 that are each configured to be received in a respective corresponding receptacle 64 in the other shell 22 of chassis 20. Disposed within each receptacle 64 is a spring-loaded processor-controlled locking mechanism that selective retains and releases the corresponding pin 63. FIG. 7 illustrates another example in which one shell 22 has one or more threaded bolts 65 that are each configured to be received in a corresponding receptacle 66 in the other shell 22 of chassis 20. Disposed in each receptacle 66 is an internally threaded nut configured to receive and retain the corresponding bolt 65. At least one of the bolt 65 and the nut is coupled to a processor-controlled electric motor that can selectively threadedly engage and disengage bolt 65 and the threaded nut to clamp and unclamp RMSD 2 to and from elongate member 100.

As will be understood from the propulsion system described below, each shell 22 can be maneuvered under processor control to appropriately position and orient each shell 22 to enable RMSD 2 to clamp and unclamp elongate member 100 in bore 24.

In various embodiments or use cases, chassis 20 may be utilized to enclose, support, and/or coupled to other components of RMSD 2, such as a control system, a sensor system, a propulsion system, a communication system, a buoyancy system, an orientation system, a power system, and/or a cable system. As noted above, in some embodiments, these features can be implemented in separate hardware components and, in other embodiments, one or more of these systems integrated into common hardware components.

Electronics housing 10 is a mechanical structure that encloses, supports, and/or is coupled to electronic components of RMSD 2. In some cases, electronics housing 10 separates the electronic components of RMSD 2 from the surrounding mediums, such as liquids and gases. Electronics housing 10 may formed of any of a variety of materials, such as plastics or metals. Electronics housing 10 may include hollows, recesses, or voids to isolate its components from one another and/or the surrounding environment. In some cases, electronics housing 10 may include multiple separate housings. In some embodiments, electronics housing 10 may be integral to or be a substitute for another component of RMSD 20. For example, electronics housing 10 may serve as an element of the buoyancy system (e.g., be either positively or negatively buoyant) or may form a portion of chassis 20. In the illustrated example, electronics housing 10 is received and removably retained in corresponding recesses 11 in shells 22.

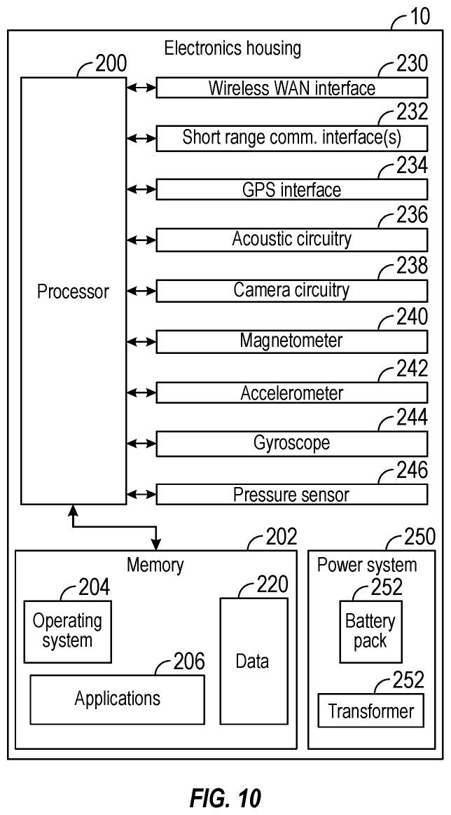

With reference now to FIG. 10, there is depicted a high-level block diagram of an exemplary embodiment of the electronics within electronics housing 10 of RMSD 2. As illustrated, in this embodiment, the electronics of RMSD 2 include a processor 200, which may include one or more processor cores for executing program code (e.g., software and/or firmware). As shown, processor 200 is coupled, either directly or indirectly, to a variety of different components within electronics housing 10. For example, processor 200 is coupled to a memory 202 (e.g., dynamic random access memory (DRAM), static random access memory (SRAM), flash memory, and/or magnetic or optical disk drive, etc.), which provides storage for data and program code (e.g., software and/or firmware) executed by processor 200. The program code stored within memory 202 can include an operating system 204, as well as applications 206. Memory 202 may additionally store data 220, which can include input data and output data of the processing performed by processor 200 or the other electronic components of RMSD 2. For example, data 220 may include location data, navigation path data, motion data, sensor data, and the like. Data 220 may also store settings that control and/or customize the operation of RMSD 2 and/or the program code it executes.

The electronics within electronics housing 10 may include a number of additional components providing, supporting and/or expanding the computational, control, sensing, storage, and/or communication capabilities of RMSD 2. For example, electronics housing 10 includes a wireless WAN interface (e.g., a transceiver and antenna) 230 supporting two-way wireless radio frequency communication with one or more communication network(s). In order to support communication with other electronics within close range electronics (e.g., other RMSDs 2 or an administrative console 106 located on a surface vessel), electronics housing 10 may be further equipped with one or more short range communication interface(s) 232. Short range communication interface(s) 232 may include short-range wireless or wired (e.g., cabled) interfaces. In some cases, multiple RMSDs 2 may be communicatively coupled to form an industrial and/or Internet of Things (IoT) network. Communication via short range communication interface(s) 232 may be conveyed, for example, via electromagnetic signals, ultrasonic pulses, acoustic (sonic) patterns, and/or optical signaling. As one specific example, communication via short range communication interface(s) 232 may be conveyed via a cable 90 (see, e.g., FIGS. 8 to 9) or umbilical connection to a surface administrative console 106. The communication via interfaces 230, 232 may be utilized to convey data or commands (e.g., navigation commands, propulsion commands, buoyancy commands, clamping and unclamping commands, etc.) between RMSD 200 and one or more other RMSD 200 or administrative console 106. As will be appreciated by those skilled in the art, administrative console 106 can be implemented by an appropriately programmed data processing system including at least a processor communicatively coupled to data storage and one or more communication interfaces supporting communication with one or more RMSDs 2.

Electronics housing 10 may further include a global positioning satellite (GPS) interface 234 (e.g., GPS receiver and GPS antenna) that receives GPS signals from GPS satellites and processes the GPS signals to provide location information to processor 200. Electronics housing 10 may also include acoustic circuitry 236 for performing acoustic (or sonic) sensing (e.g., of defects in an object or of an object's distance, angle, and/or location) and/or communication, as well as camera circuitry 238 for interfacing or more optical, infrared, or other cameras disposed on chassis 20. The electronics within electronics housing 10 can additionally include a magnetometer 240, a pressure (depth) sensor 246, and an accelerometer 242 that can be utilized together with gyroscope 244 to sense and/or determine the position, depth, attitude, velocity, and/or acceleration of RMSD 2.

Electronic housing 10 further includes a power system 250 that powers processor 200, the other components within electronics housing 10, and the propulsion system described below. Power system 246 may include, for example, a battery pack 252, a transformer 252, and an unillustrated power port through which battery pack 252 may be charged from a power source or wireless inductive charging device. In some examples, power system 250 may additionally support the supply of power to other RMDS 2 via an external cable 90. In some examples, power system 250 may alternatively or additionally include a liquid accumulator or a gas accumulator, which when actuated can serve as an energy source. In some examples, power system 250 can include a kinetic energy battery charger, which converts the reciprocating motion of a weighted spring into electrical current that can be utilized to power RMSD 2 and/or charge battery pack 252.

Although FIG. 10 illustrates a number of components separately for ease of understanding, it will be appreciated by those skilled in the art that, in at least some embodiments, multiple of the illustrated components may be integrated within a common integrated circuit die or package.

Referring again to FIGS. 1 to 7, chassis 20 also houses and/or supports a propulsion system. For example, in the illustrated embodiment, chassis 20 includes a plurality of liquid guideways 34 that permit and direct the flow of liquid through chassis 20. In some embodiments, propellers 31 (also known as “screws”) are positioned within at least some of liquid guideways 34 and can be selectively and independently rotated (or counter-rotated) under control of processor 200 in electronics housing 10 to force the liquid in which chassis 20 is submerged through the liquid guideways 34, imparting desired motion vectors to RMSD 2. In at least one embodiment, each shell 22 includes at least one propeller 31 and associated liquid guideway 34 oriented in each of three orthogonal directions (e.g., the X, Y, Z axes in a Cartesian coordinate system). As will be appreciated, the motion vectors can be utilized to move RMSD 2 through the liquid, enable RMSD 2 to hold a fixed position in the presence of other forces acting on RMSD 2, or change the orientation or attitude of RMSD 2. Propellers 31 can be driven, for example, by electric motors or by electrical magnetic induction controlled by processor 200.

In at least some embodiments, the propulsion system may alternatively or additionally include a jet pump having an intake port into which the liquid is drawn by the jet pump and an output port through which the jet pump expels the liquid. The output port has a fluid connection to a valved nozzle system. In such embodiments, the electronics in electronics housing 10 controls the operation of the jet pump and the opening and closing of the valve(s) of the nozzle system to direct jets of the liquid from one or more nozzles to orient and/or to move each of shells 22 (and thus RMSD 2) in a desired manner.

Chassis 20 may further house and/or support a buoyancy system. For example, in some embodiments, chassis 20 includes one or more buoyancy control elements (BCEs) 51, which can each be removably housed in a recess 11 in chassis 20. Although not required, it is preferred in some embodiments to promote design modularity by implementing the recesses 11 for BCEs 51 and the recesses 11 for electronic housing 10 with the same dimensions. In at least some embodiments, the dimensions of recesses 11 can also be the same as those of liquid guideways 34. A BCE 51 can be selectively inserted into a recess 11 of RMSD 2 or removed from a recess 11 as desired for the parameters of a given use case (e.g., the specific gravity of the liquid in which RMSD 2 is submerged, depth of operation, etc.). Each BCE 51 can have either a negative buoyancy or a positive buoyancy in the liquid within which RMSD 2 is submerged. In some examples, a BCE 51 can include a weight (e.g., lead, water, etc.). In some examples, a BCE 51 can be formed of a material of less density than the liquid in which RMSD 2 is to be used. In some examples, a BCE 51 can include an enclosure filled with air or another gas. In some examples, a BCE 51 can include an enclosed chamber having a valve. By controlling the relative amounts of gas (e.g., air) and liquid (e.g., water) within the enclosed chamber (e.g., utilizing processor 200), the BCE 51 can selectively be made positively buoyant or negatively buoyant for a given use case. Further, in some embodiments, a BCE 51 may be integral to chassis 20.

Referring now to FIGS. 8 to 9, in some embodiments or use cases, one or more cables 90 be utilized to physically link multiple RMSDs 2. Each cable 90 can include, for example, a mechanical tension member (e.g., a metal rod, a rope, or Kevlar strap), a communication link, and/or an electrical power link. In various embodiments, a cable 90 can be rigid and thus prevent or resist relative movement between linked RMSDs 2 or can be flexible and thus allow relative movement of linked RMSDs 2. In various examples, a cable 90 can be metallic or non-metallic.

As further depicted in FIGS. 8 to 9, one or more RMSDs 2 can be clamped to an elongate member 100 (e.g., a cable, conduit, pipeline, tube, fluid hose, etc.) with the elongate member 100 fixedly retained in the bore 24 of each RMSD 2. Elongate member 100 may be rigid or flexible. Elongate member 100 may be formed of any material and may be of any profile or shape. The propulsion systems of RMSD(s) 2 clamped to elongate member 100 can be individually and collectively controlled (e.g., by the administrative console 106 or by a controlling RMSD 2) in a coordinated fashion to position elongate member 100 within liquid 102 in a desired manner, where positioning the elongate member 100 may include extending (e.g., uncoiling or unspooling), retracting (e.g., coiling or spooling), orienting, manipulating, bending, straightening, translating, and/or maneuvering elongate member 100. For example, the propulsion systems of RMSDs 2 can be individually controlled to create or maintain a bend or curve in elongate member 100, as explicitly shown in FIG. 9.

In one particular use case, a first portion of the length of elongate member 100 may be spooled on a reel, and a second portion of elongate member 100 including a free end of elongate member 100 may be submerged within liquid 102 below surface 104. In this use case, multiple RMSDs 2 can be clamped to the second portion of elongate member 100. The RMSDs 2 are controlled to propel elongate member 100 through liquid 102 in a coordinated manner, thus moving the free end of elongate member 100 away from the reel to a desired point. If desired, RMSDs 2 can be controlled to automatically unclamp from elongate member 100 (e.g., by releasing closure elements 63 or 65), return to respective specified locations, re-clamp to elongate member 100, and then unspool an additional length of elongate member 100 from the reel.

In another use case, multiple RMSDs 2 may be controlled to work in a coordinated fashion to transport or maneuver elongate member 100 in liquid 102 while maintaining elongate member 100 a fixed shape, such that the shape of the elongate member 100 is not altered, but is instead translated in space by the RMSDs 2. For example, FIG. 8 illustrates multiple RMSDs 2 operating in unison to maintain elongate member 100 is a straight configuration while transporting elongate member 100 through liquid 102.

In another use case, multiple RMSDs 2 can be controlled to separately transport each of multiple unconnected segments of an elongate member 100 through liquid 102 to respective locations, to maneuver to place the segments into desired orientations, and to then assemble the multiple segments to each other and/or to a preexisting structure.

In another use case, multiple RMSDs 2 can be clamped to an elongate member 100 such that the elongate member 100 serves as a central frame enabling the multiple RMSDs 2 to coordinate their movements through liquid 102. It will be appreciated that RMSDs 2 can be controlled to clamp and/or unclamp from the elongate member 100 to dynamically provide a selected number of engaged RMSDs 2 and thus provide a desired propulsive velocity, force, and acceleration or a desired negative or positive buoyancy.

It should further be appreciated that multiple RMSDs 2 may be connected by a cable 90 in a desired fashion and then controlled to move through liquid 102 to respective predetermined locations. Upon reaching its respective predetermined location, each RMSD 2 can clamp to an elongate member 100 and then move through liquid 100 in concert with the other RMSDs 2 to position the elongate member 100 in a desired manner.

In use, one or more RMSDs 2 are clamped to an elongate member. For example, one or more of the RMSD(s) 2 can be clamped to the elongate member 100 out of the liquid 102 by a human operator manually clamping the RMSD 2 to elongate member 100. Alternatively or additionally, one or more of the RMSD(s) 2 can be automatically clamped to at least a portion of elongate member 100 that is within liquid 102 as described above. RMSDs 2 can be clamped to elongate member 100 with any desired distance between each RMSD 2. Each RMSD 2 can optionally be coupled to another RMSD 2 and/or an administrative console 106 by a cable 90.

The administrative console 106 can communicate to each RMSD 2 (e.g., in a command or a set of navigation waypoints) an initial three-dimensional (3D) position and/or orientation from which that RMSD 2 is to initiate positioning of elongate member 100. The administrative console 106 can additionally provide commands and/or a set of navigation waypoints to the RMSDs 2 to control the RMSD(s) 2 to move in concert in a specified manner to position the elongate member 100 as desired.

While RMSD(s) 2 are positioning elongate member 100, the administrative console 106 can receive feedback regarding the position of elongate member 100. Feedback regarding the position of elongate member 100 may be provided by RMSD(s) 2. Feedback regarding positioning of elongate member 100 can alternatively or additionally be provided by supplemental sensors external to RMSD(s) 2. To facilitate use of such supplemental sensors, some RMSDs 2 can be formed utilizing different materials, formed in different overall shapes, or in different sizes, enabling the supplemental sensors to be able to identify and differentiate the RMSDs 2. In at least some embodiments, the administrative console 106 can provide relevant positioning and orientation information back to RMSD(s) 2, allowing RMSD(s) 2 to control positioning of elongate member 100 in a closed loop manner. In some embodiments, one or more RMSDs 2 may omit orientation and positioning systems, but include power and propulsion systems. In such embodiments, one or more other RMSDs 2 including communication and orientation systems may provide guidance and propulsion information to the RMSD(s) 2 having no internal orientation and positioning systems.

Based on the mass and/or size of the elongate member, a greater number of RMSDs 2 may be dynamically clamped to elongate member 100 to provide a greater propulsive and/or buoyant force. Alternatively, if a lesser propulsive and/or buoyant force is desired or required, one or more RMSDs 2 can be dynamically unclamped from elongate member 100.

As has been described, in at least one embodiment, a remote modular submersible device is suitable for various subsurface operations in a liquid, such as freshwater, salt water, hydrocarbon(s), and/or chemical(s). The remote modular submersible device includes a chassis and a clamping system in the chassis. The clamping system is configured to clamp the chassis to an elongate member. The remote modular submersible device also includes a propulsion system in the chassis. The propulsion system is configured to propel and orient the chassis in a liquid in which the chassis is submerged. The remote modular submersible device additionally includes a processor configured to control at least the propulsion system.

While various embodiments have been particularly shown and described, it will be understood by those skilled in the art that various changes in form and detail may be made to the disclosed embodiments without departing from the scope of the appended claims and these alternate implementations all fall within the scope of the appended claims. It should be understood that the invention is not limited in its application to the details of construction or to the arrangements of the components set forth in the description or illustrated in the drawings. The claimed inventions are capable of being realized in other embodiments and of being practiced and carried out in various ways. It should also be understood that the phraseology and terminology employed herein are for the purpose of the description and should not be regarded as limiting.

What is claimed is:

1. A remote modular submersible device, comprising:
a chassis;
a clamping system in the chassis, wherein the clamping system is configured to removably clamp the chassis to an elongate member;
a propulsion system in the chassis, wherein the propulsion system is configured to propel and orient the chassis in a liquid in which the chassis is submerged; and
a processor in the chassis, wherein the processor is configured to control at least the propulsion system.

2. The remote modular submersible device of claim 1, wherein:
the chassis includes at least first and second shells having corresponding recesses formed therein, the recesses forming a bore for receiving the elongate member.

3. The remote modular submersible device of claim 2, wherein:
the propulsion system includes a plurality of propellers; and
each of the first and shells includes at least one of the plurality of propellers.

4. The remote modular submersible device of claim 1, wherein the propulsion system includes a plurality of propellers.

5. The remote modular submersible device of claim 1, wherein the clamping system includes a closure element.

6. The remote modular submersible device of claim 5, wherein the closure element includes a processor-controlled locking mechanism.

7. The remote modular submersible device of claim 5, wherein the closure element includes a threaded locking mechanism.

8. The remote modular submersible device of claim 5, wherein:
the chassis includes at least first and second shells; and
the closure element includes a hinge;

9. The remote modular submersible device of claim 1, wherein:
the chassis has a plurality of liquid guideways propulsion system through the chassis;
the propulsion system includes a plurality of propellers disposed in the plurality of liquid guideways;
the chassis includes at least one recess; and
the processor is disposed in an electronics housing disposed in the at least one recess.

10. The remote modular submersible device of claim 9, wherein the at least one recess is configured with common dimensions with the plurality of liquid guideways.

11. A system, comprising:
a plurality of remote modular submersible devices in accordance with claim 1.

12. The system of claim 11, further comprising a cable communicatively coupling the plurality of remote modular submersible devices.

13. The system of claim 11, further comprising the elongate member.

14. The system of claim 11, further comprising an administrative console communicatively coupled to the plurality of remote modular submersible devices.

15. A method, comprising:
providing a remote modular submersible device, including:
a chassis;
a clamping system in the chassis, wherein the clamping system is configured to removably clamp the chassis to an elongate member;
a propulsion system in the chassis, wherein the propulsion system is configured to propel and orient the chassis in a liquid in which the chassis is submerged; and
a processor in the chassis, wherein the processor is configured to control at least the propulsion system;
clamping the remote modular submersible device to the elongate member; and
positioning the elongate member in a liquid utilizing the remote modular submersible device.

16. The method of claim 15, wherein:
the remote modular submersible device is a first remote modular submersible device among a plurality of remote modular submersible devices;
the clamping includes removably clamping the plurality of remote modular submersible devices to the elongate member; and
the method further comprises coordinating movement of the plurality of remote modular submersible devices through the liquid.

17. The method of claim 16, wherein the positioning includes bending the elongate member in the liquid.

18. The method of claim 15, wherein the clamping includes navigating the remote modular submersible device through the liquid to the elongate member and automatically clamping the remote modular submersible device to the elongate member under control of the processor.

19. The method of claim 18, further comprising:
after the positioning, automatically unclamping the remote modular submersible device from the elongate member.

20. The method of claim 15, wherein the positioning includes extending a length of the elongate member in the liquid.
